(19) United States
(12) Patent Application Publication
(10) Pub. No.: US 2018/0319032 A1
(43) Pub. Date: Nov. 8, 2018

(54) HOLE PUNCH ASSEMBLY AND METHOD

(71) Applicant: Gordon Myles Moeggenborg, Shepherd, MI (US)

(72) Inventor: Gordon Myles Moeggenborg, Shepherd, MI (US)

(21) Appl. No.: 15/972,139

(22) Filed: May 5, 2018

Related U.S. Application Data
(60) Provisional application No. 62/502,230, filed on May 5, 2017.

(51) Int. Cl. B26D 7/00; B26F 1/36; B26D 7/01

(52) U.S. Cl. CPC B26D 7/0006; B26F 2001/365; B26D 7/015; B26F 1/36

(57) ABSTRACT

A hole punch assembly includes two locating features for forming holes in a trim piece overlying a metal sheet with ridges formed therein. One locating feature is a groove into which one of the ridges is insertable. The other locating feature is a portion of the outer surface configured such that, when one of the ridges in in the groove and the trim piece contacts the portion of the outer surface, a punch is positioned to form a hole in the trim piece.

### CROSS-REFERENCE TO RELATED APPLICATION

This application claims the benefit of U.S. Provisional Application No. 62/502,230, filed May 5, 2017, and which is hereby incorporated by reference in its entirety.

### TECHNICAL FIELD

This disclosure relates to punches for forming holes in metal sheets.

### BACKGROUND

Metal sheets are often used in building construction, such as to form roofs or walls. The metal sheets are typically attached to a frame or roof beams by fasteners such as nails or screws that must pass through the metal sheet. Metal trim pieces are often attached at the edges of the metal sheets.

### SUMMARY

A hole punch assembly is provided for forming holes in a trim piece disposed on a sheet having ridges. The hole punch assembly includes a body having a first surface portion defining a groove and a second surface portion generally perpendicular to the first surface portion. A punch is operatively connected to the body and movable between a retracted position and an extended position. The groove is sufficiently sized and shaped to at least partially contain one of the ridges such that the body is selectively slidable along the ridge when the ridge is at least partially within the groove.

The hole punch assembly is configured such that when one of the ridges is at least partially within the groove and the trim piece contacts the second surface portion, the punch contacts the trim piece during movement from the retracted position to the extended position, and can thereby form a hole through which a fastener can be inserted to secure the trim piece to the metal sheet and/or underlying structure.

The groove functions as a locating feature that ensures the holes are formed at one of the grooves, which facilitates even spacing of holes along the trim piece. The second surface portion functions as another locating feature that ensures the holes are consistently formed a predetermined distance from the edge of the trim piece. The hole punch assembly provided herein provides a rapid and efficient way of obtaining consistent and evenly spaced holes, which greatly enhance the aesthetics of the resulting structure. A method of using the hole punch assembly is also provided.

The above features and advantages and other features and advantages of the present disclosure are readily apparent from the following detailed description of the best modes for carrying out the disclosure when taken in connection with the accompanying drawings

### BRIEF DESCRIPTION OF THE DRAWINGS

FIG. 1 is a schematic side view of a hole punch assembly;

FIG. 2 is a schematic front view of the hole punch assembly;

FIG. 3 is a schematic, bottom view of the hole punch assembly;

FIG. 4 is a schematic, cross-sectional side view of a portion of the hole punch assembly with a pin in a retracted first position;

FIG. 5 is a schematic, top view of a metal sheet with ridges, and the hole punch assembly engaging one of the ridges;

FIG. 6 is a schematic, cross-sectional, front view of a portion of the hole punch assembly showing the ridge disposed within the groove; and

FIG. 7 is schematic, cross-sectional side view of a portion of the hole punch assembly engaged with a trim piece and with the pin in an extended second position.

### DESCRIPTION OF THE PREFERRED EMBODIMENTS

Referring to the Figures, wherein like reference numbers refer to like components throughout, a hole punch assembly 10 includes a body 14 having an outer surface 18. The outer surface 18 includes a first planar surface portion 22 and a second planar surface portion 26 that is spaced apart from, and parallel to, the first planar surface portion 22. The body 14 defines a hole 30 that extends from the first planar surface portion 22 to the second planar surface portion 26. The body 14 is shown as being formed from a single piece of material. However, and within the scope of the claims, the body 14 may also be multiple pieces of material operatively interconnected.

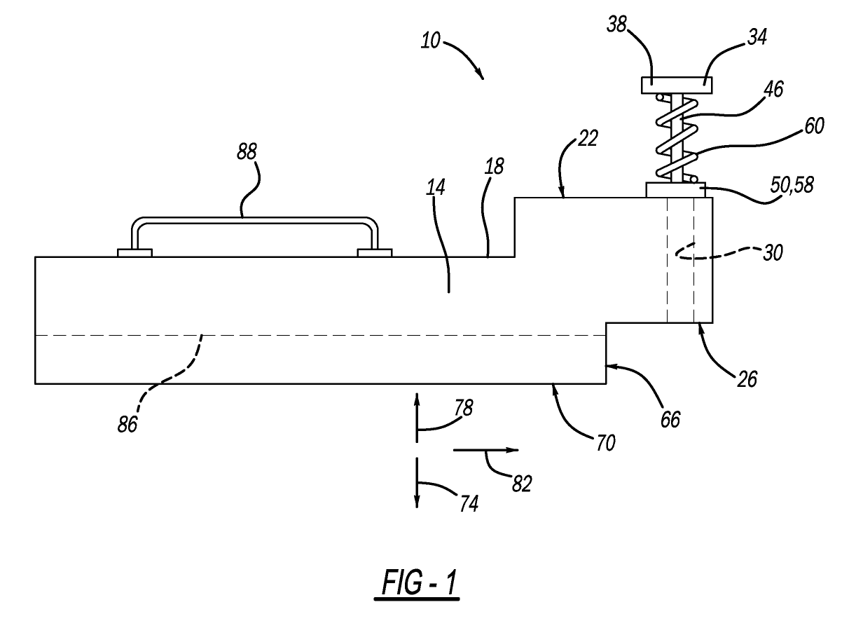

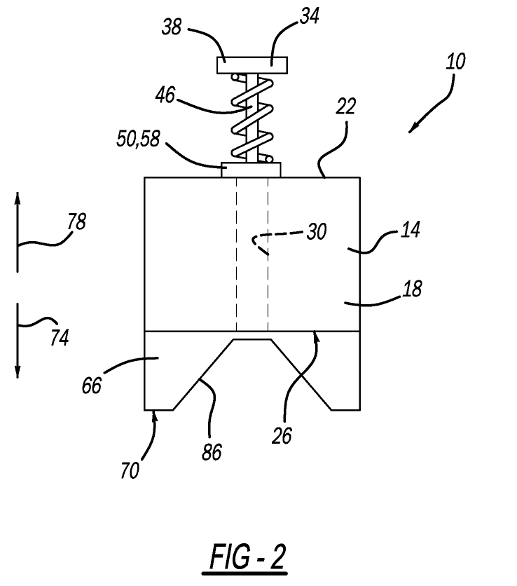

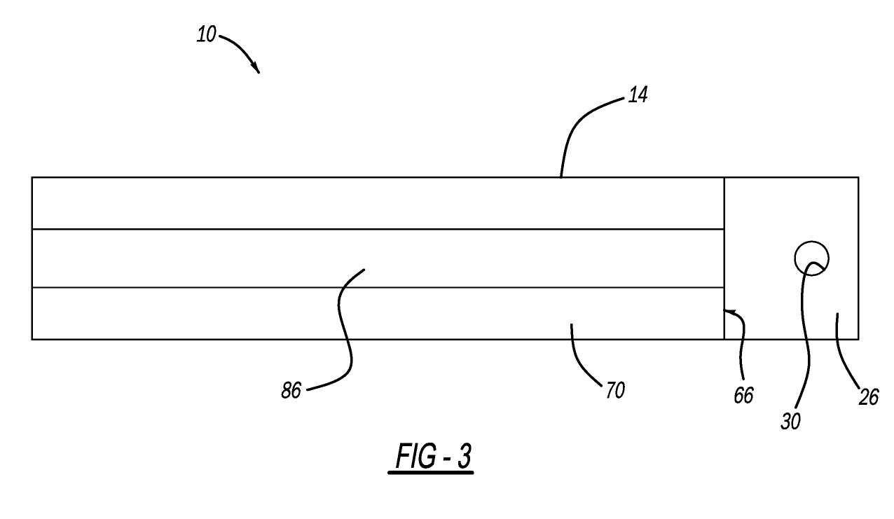

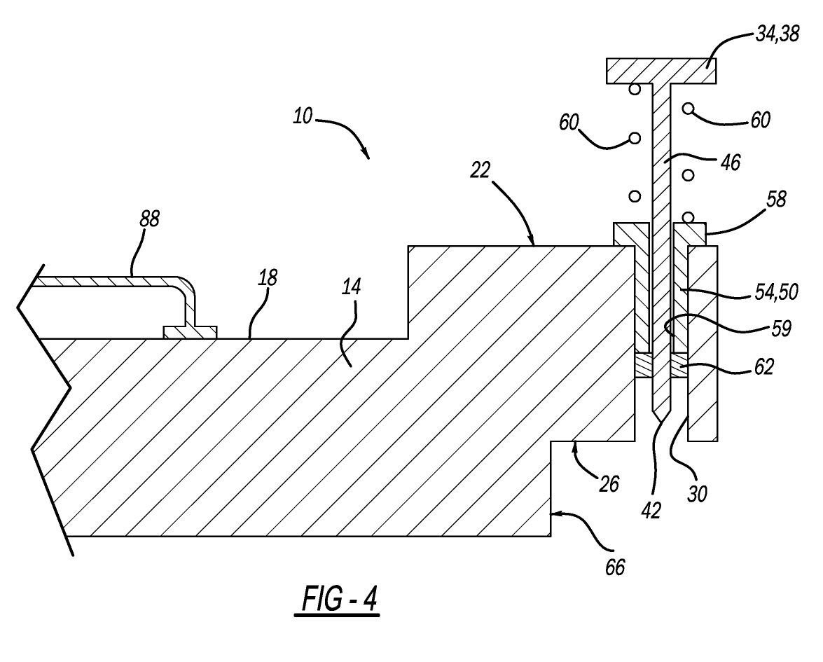

Referring specifically to FIG. 4, the assembly 10 includes a punch 34 having a head 38, a tip 42, and a shaft 46 that interconnects the head 38 and the tip 42. The punch 34 is at least partially disposed within the hole 30 such that the head 38 and a portion of the shaft 46 protrude from the first planar surface portion 22. The punch 34 is shown in a first, retracted position in FIGS. 1-4, in which the tip 42 is within the hole 30 and does not protrude from the second planar surface portion 26.

The punch assembly 10 includes a cylindrical metal sleeve 50 having a first sleeve portion 54 and a second sleeve portion 58. The first sleeve portion 54 is disposed within the hole 30. The outer diameter of the first sleeve portion 54 is slightly smaller than the diameter of the hole 30, and an adhesive may be placed between the outer surface of the first sleeve portion 54 and the surface defining the hole 30 to retain the sleeve 50 therein. Alternatively, the first sleeve portion 54 may be slightly oversized of the hole 30 so that the sleeve 50 is retained within the hole 30 by friction.

The second sleeve portion 58 has an outer diameter greater than the diameter of the hole 30, and thus the second sleeve portion 58 contacts surface portion 22. The shaft 46 of the punch 34 extends through a cylindrical passageway 59 defined by the sleeve 50, and has a diameter slightly less than the diameter of the passageway 59. Accordingly, the sleeve 50 substantially limits the movement of the punch 34 to linear translation.

A coil spring 60 is disposed between, and contacts, the head 38 and the second sleeve portion 58. The spring 60 biases the punch 34 in its first, retracted position. A ring 62 is mounted to the shaft 46 outside the sleeve 50 and has an outer diameter greater than the diameter of the passageway 59; the ring 62 thereby prevents the removal of the punch 34 from the hole 30 because of physical part interference between the ring 62 and the sleeve 50.

In the embodiment depicted, the ring 62 is connected to the punch 34 after the punch 34 is inserted through the passageway 59 to retain the punch 34. In an alternative embodiment (not shown), the ring 62 is integrally formed in the shaft of the punch, and the head 38 of the punch is a separate piece from the shaft; in the alternative embodiment, the head is mounted to the shaft by a fastener after the punch is inserted through the passageway 59.

The hole punch assembly 10 is especially suited to forming holes in trim pieces adjacent to metal roofing or siding for securing the trim pieces to the roofing or siding and/or the underlying frame or support structure. More specifically, the body 14 of the hole punch assembly 10 includes features for accurately and efficiently positioning the punch 34 to produce consistently spaced holes in the trim pieces.

More specifically, and with reference to FIG. 1, the body 14 defines a third planar surface portion 66 of the outer surface 18; the third planar surface portion 66 extends perpendicularly from the second planar surface portion 26. A fourth planar surface portion 70 extends perpendicularly from the third planar surface portion 66. Second and fourth planar surface portions 26, 70 both face a first direction 74; first planar surface portion 22 faces a second direction 78 that is opposite the first direction 74; and the third planar surface portion 66 faces a third direction 82 that is perpendicular to the first and second directions 74, 78. As used in the claims, a surface or portion of a surface is “generally perpendicular” to another surface or surface portion if it is within forty-five degrees of perpendicular.

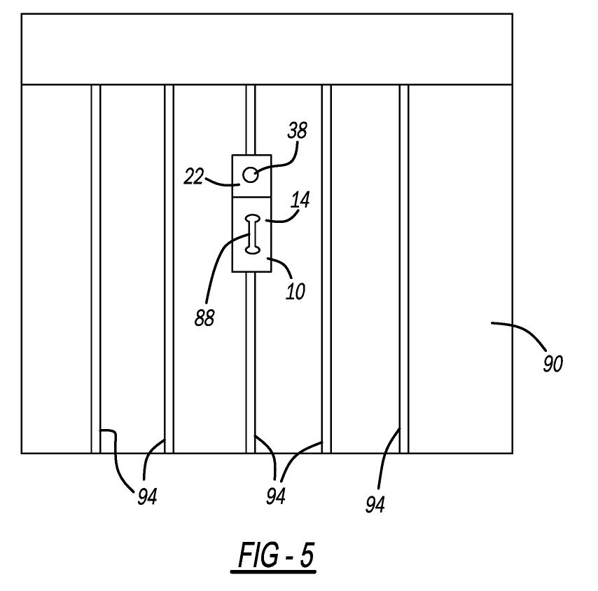

Referring to FIGS. 1-3, the fourth planar surface portion 70 defines an elongated groove 86 that is open at both ends, including through the third planar surface portion 66. A handle 88 is mounted to the body 14 for ease of handling. Referring to FIG. 5, a metal sheet 90, which may be a metal roof or metal siding, includes a plurality of ridges 94 formed therein. Adjacent to the metal sheet is a trim piece 98 partially overlying the metal sheet 90.

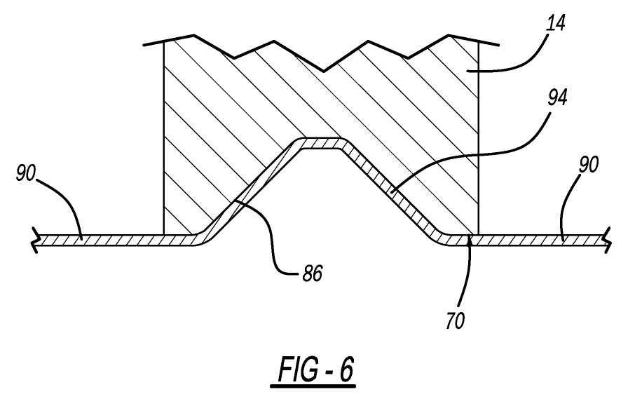

One method of using the hole punch assembly 10 includes placing the hole punch assembly 10 on the metal sheet 90 such that one of the ridges 94 extends into the groove 86, as shown in FIGS. 5 and 6. Referring to FIGS. 5 and 6, the groove 86 is sized and shaped such that the surfaces defining the groove 86 contact the surfaces defining the ridge 94 and thereby limit any sliding movement of the assembly 10 along the sheet 90 to substantially linear translation in two opposite directions, i.e., back and forth along the ridge 94.

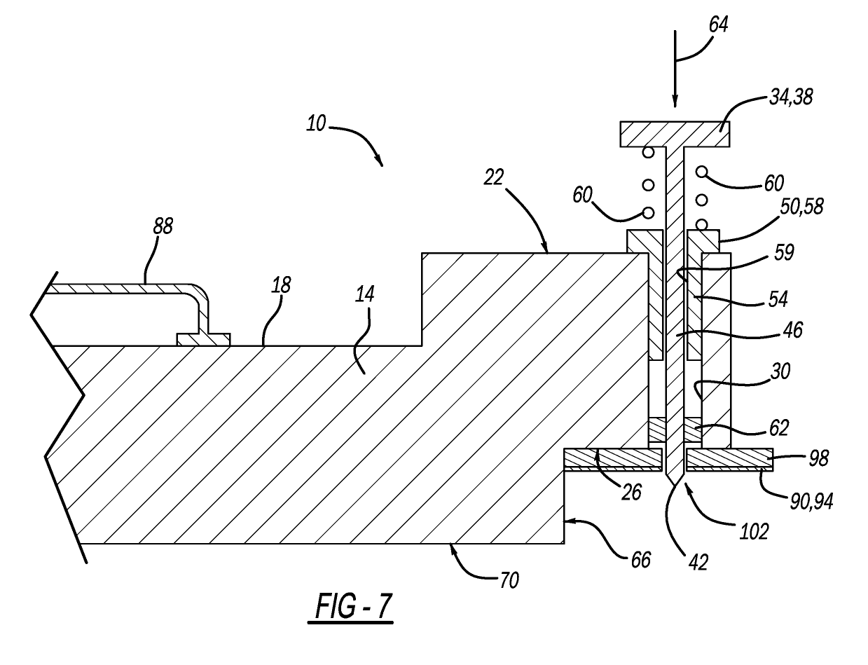

The method also includes sliding the punch assembly 10 along the ridge 94 (with the ridge 94 remaining at least partially within the groove 86) in the direction of the trim piece 98 until the third planar surface portion 66 contacts the edge of the trim piece 98, as shown in FIG. 7. Referring to FIG. 7, a force 64 is then applied to the head 38 of the punch 34, such as by striking the head 38 with a hammer or other striking implement, thereby overcoming the bias of the spring 60 and moving the punch 34 to its second, extended position as shown in FIG. 7.

In the second, extended position, the tip 42 and a portion of the shaft 46 are outside the hole 30 and protrude from the second planar surface portion 26. The trim piece 98 contacts or is adjacent to the second planar surface portion 26, and the tip 42 extends through the trim piece 98 and the metal sheet 90, thereby forming a hole 102 through which a fastener can be inserted to retain the trim piece to the metal sheet.

Accordingly, the groove 86 forms one locating feature for ensuring that the hole is formed along one of the ridges, and the third planar surface portion 66 forms another locating feature that ensures the hole is formed a desired distance from the edge of the trim piece. The assembly 10 may be placed on multiple ridges 94 to form a plurality of holes in the trim piece 98.

While the best modes for carrying out the invention have been described in detail, those familiar with the art to which this invention relates will recognize various alternative designs and embodiments for practicing the invention within the scope of the appended claims.

1. A hole punch assembly comprising:
a body having an outer surface, said outer surface having first, second, third, and fourth surface portions;
said body defining a hole that extends through the first surface portion and the second surface portion;
a punch having a head and a tip, said punch being partially within the hole and movable between a retracted position in which the tip is within the hole and the punch does not protrude from the second surface portion, and an extended position in which punch protrudes from the second surface portion and the tip is outside the hole;
wherein the third surface portion is generally perpendicular to the second surface portion; and
wherein the fourth surface portion is generally perpendicular to the third surface portion and defines a groove.

2. The hole punch assembly of claim 1, wherein the third surface portion extends from the second surface portion; and
wherein the fourth surface portion extends from the third surface portion.

3. The hole punch assembly of claim 1, further comprising a spring that biases the punch in the retracted position.

4. The hole punch assembly of claim 1, further comprising a handle mounted to the body.

5. The hole punch assembly of claim 1, wherein the groove is open at both of ends of the groove.

6. A hole punch assembly for forming a hole in a trim piece on a metal sheet having a plurality of ridges, the hole punch assembly comprising:
a body having a first surface portion defining a groove and a second surface portion generally perpendicular to the first surface portion;
a punch operatively connected to the body and movable between a retracted position and an extended position;
wherein the groove is sufficiently sized and shaped to at least partially contain one of the ridges such that the body is selectively slidable along the ridge when the ridge is at least partially within the groove; and
wherein the hole punch assembly is configured such that when one of the ridges is at least partially within the groove and the trim piece contacts the second surface portion, the punch contacts the trim piece during movement from the retracted position to the extended position.

7. The hole punch assembly of claim 6, wherein the body defines a hole; and
wherein the punch is partially disposed within the hole.

8. The hole punch assembly of claim 6, further comprising a handle mounted to the body.

9. A method of forming holes in a trim piece on a metal sheet that defines a plurality of ridges, the method comprising:
obtaining a hole punch assembly;
said hole punch assembly including a body having a first surface portion defining a groove and a second surface portion generally perpendicular to the first surface portion, and a punch operatively connected to the body and movable between a retracted position and an extended position;
positioning the hole punch assembly relative to the metal sheet such that one of the ridges is at least partially within the groove and the trim piece contacts the second surface portion; and
causing the punch to move from the retracted position to the extended position and thereby form a hole in the trim piece.

10. The method of claim 9, wherein said positioning the hole punch assembly includes sliding the hole punch assembly along the ridge until the second surface portion contacts the trim piece.

11. The method of claim 9, wherein said causing the punch to move also forms a hole in the metal sheet.
